(19) United States
(12) Patent Application Publication
(10) Pub. No.: US 2008/0118759 A1
(43) Pub. Date: May 22, 2008

(54) Mechanical resonators fabricated out of bulk-solidifying amorphous metal alloys

(76) Inventor: David M. Korpi, Salinas, CA (US)

Correspondence Address: DAVID MICHAEL KORPI, 405 Monterey Avenue, Pacific Grove, CA, 93950, US

(21) Appl. No.: 11/562,058

(22) Filed: Nov. 21, 2006

(51) Int. Cl. G01H 13/00

(52) U.S. Cl. 428/457; 74/1 SS

(57) ABSTRACT

The use of bulk-solidifying amorphous metal alloys, frequently called “liquid metals”, are disclosed as a preferred material of construction for the manufacture of mechanical resonators, such as mechanical resonators utilized in the following: systems using tuning forks and variants of tuning forks, inertial microbalances, vibrating level detectors, vibrating viscosity and rheology measuring instruments, vibrating tube meters, such as Coriolis mass flow meters, vibrating structure gyroscopes, vortex flow meters, sonotrodes for various applications such as welding and medical applications, and piezoelectric activated mechanical resonators. A method of attaining high mechanical Q factors, sensitivity, elasticity, hardness, and high specific strength properties offered by the use of bulk-solidifying amorphous metal alloys in the manufacture of mechanical resonators is disclosed.

### BACKGROUND OF THE INVENTION

1. Field of the Invention

The present invention relates generally to the materials of construction utilized for the manufacture of mechanical resonators used in general industry, medicine, physics, and other fields of interest. The invention more particularly relates to the selection of the materials of construction of mechanical resonators such as, and not limited to the following: Systems using tuning forks and variants of tuning forks, inertial microbalances, vibrating level detectors, vibrating viscosity and rheology measuring instruments, vibrating tube meters, such as Coriolis mass flow meters, vibrating structure gyroscopes, vortex flow meters, sonotrodes for various applications such as welding and medical applications, and piezoelectric activated mechanical resonators.

2. Brief Description of the Prior Art

Most mechanical resonators are fabricated out of metallic, quartz, or glass alloys. Designers select the materials of construction for mechanical resonators based on the optimization of specific operating characteristics such as high mechanical Q factors, sensitivity, elasticity, hardness, and/or high specific strength properties. Designers frequently discover their selection of the materials of construction for mechanical resonators dictate that it is necessary to sacrifice properties, such as specific strength or sensitivity, resulting in having to accept a reduced set of operating characteristics of the mechanical resonator.

A force driving the development of improved performance of mechanical resonators is the need for more robust mechanical resonators with higher Q factors that come with the emergence of advances in materials science and metallurgy.

Another force driving the development of improved performance of mechanical resonators is the emergence of improved technology in electronics that can take advantage of the improvements offered in the performance of mechanical resonators.

Mechanical resonators, by definition, require the selection of materials of construction that exhibit high mechanical Q factors. As such it has been a constant battle for designers to select a material for the fabrication of mechanical resonators that exhibit high mechanical Q factors while additionally posessing properties such as high strength. As an example, a piano tuning fork made out of single crystal quartz will have a very high mechanical Q factor but a very low strength. Such a tuning fork would break the first time it is struck. Most piano tuning forks are made out of aluminum, which has sufficient strength to survive in the field but have relatively low mechanical Q factors. Similarly, a piano tuning fork made out of single crystal titanium would have high strength and a much higher mechanical Q factor, when compared to aluminum, but it would be prohibitively expensive.

We define the mechanical Q factor of a resonator as a measure of the rate at which a vibrating system dissipates its energy. A higher Mechanical Q factor indicates a lower rate of energy dissipation. For example, a tuning fork made out of a high mechanical Q factor material, such as titanium will resonate longer, and have a higher Q factor than a tuning fork made out of wood, that would only resonate for a few seconds. Quartz crystals, such as those used in computers have very high mechanical Q factors and resonate at very narrow frequencies. For example a high quality quartz crystal will resonate at 260.000000 MHz but not at 260.000001 MHz or 259.999999 MHz. In other words, the higher the Q the more “single valued” the resonant frequency.

Additionally, the materials of construction of mechanical resonators frequently revolve around the selection of materials with low modulus of elasticity coefficients so that the mechanical resonator will resonate at the same frequency when exposed to a selected temperature range. The selection of low modulus of elasticity is frequently in conflict with high mechanical Q factors.

Detailed below are a few exemplary systems, or families, utilizing mechanical resonators so that the reader may more fully grasp the similarity of the challenges facing designers of mechanical resonators. They exemplify how mechanical resonators may disguise themselves in various applications.

Inertial Microbalances:

Referring now to oscillating inertial microbalance mass measurement systems it is known in the art that mechanical resonating systems have a large dependency on their environment, materials of construction, and method of manufacturing. A significant contribution to the adverse effects can come from a non-ideal mechanical resonator or resonating element that is at the heart of the classical oscillating inertial microbalance. Exemplary construction and operation of such oscillating inertial microbalance mass measurement devices are disclosed in U.S. Pat. Nos. 3,926,271, 4,391,338, 6,444,927, and 6,784,381 which patents are hereby incorporated herein by reference in their entirety. It will be apparent that these patents all relate to minimizing errors associated with determining mass based on the mechanical resonant frequency of the system. In nearly ALL of these systems the materials of construction are either a very delicate quartz alloy or some metallic alloy as detailed in the patents.

The need for selection of novel materials of construction for mechanical resonators have existed for over twenty years. One example of a mechanical resonator fabricated out of a glass alloy with a low modulus of elasticity is discussed in U.S. Pat. No. 4,836,314, by Rupprecht, entitled “Novel glass elements for use in balances”. This patent teaches how to alloy the glass to attain a near zero modulus of elasticity coefficient. However, the resulting system is extremely fragile. The gains enjoyed by selecting a nearly constant modulus of elasticity coefficient are outweighed by a very fragile system while exhibiting a fairly high mechanical Q factor. Given that most resonant systems require robust resonators we observe that designers seek to discover materials of construction that offer characteristics allowing for optimally designed systems utilizing mechanical resonators.

The importance of a near constant elastic modulus is explained by Rupprecht as follows: “In most laboratory balances, acceleration is provided by gravity. Inertial balances, on the other hand, provide the acceleration by mechanical (usually oscillating) motion. For gravity-dependent balances, masses are measured by counterweights or through deformation leading to a restoring force in a supporting member. These restoring forces are produced by elastic deformation or torsional moments in supporting members. These quantities result from the stiffness of the members which are characterized by their elastic or Young's modulus. For an accurate measurement, therefore, it is important that Young's modulus remain essentially constant, and for measurement of very small masses or for extremely accurate measurement of mass the constancy of Young's modulus is critical. In virtually all materials, however, the value of Young's modulus changes with temperature. In the determination of very small masses, or for high resolution, unless the temperature is carefully controlled this effect can result in significant errors. Constant temperature can be achieved and maintained only within certain limits even with considerable effort and expense, and the equipment required also contributes to operational inconvenience. In some applications adequate temperature control is nearly impossible, which results in a severe degradation or loss of resolution. These problems can be significantly reduced by the use of material which has low or minimal temperature dependence of Young's modulus over the nominal temperature operating range of the system.”

While the Rupprecht patent above observes the following “In some applications adequate temperature control is nearly impossible” we know now that systems exist, more than seventeen years later, to attain adequate temperature control and measurement methods that make the need for nearly constant elastic modulus mechanical resonators less important than designing mechanical resonators that exhibit high mechanical Q factors and high durability.

The low modulus of elasticity properties, attained in the past by alloying, have been addressed in the industry by compensating for the temperature changes, as indicated in U.S. Pat. No. 6,444,927 by Korpi, entitled “Microbalance with reduced temperature and or pressure sensitivity”.

The particular advantages of using temperature control and measurement, as discussed in the Korpi patent, as well as metal alloys in an exemplary resonant structure is disclosed and discussion is made for precise temperature control and the selection of a metal alloy, to attain a high mechanical Q factor of a resonant structure as well normalizing the elastic modulus so that the mechanical Q factor is nearly constant over a given temperature range.

Additionally, patent application number 20060086174 of Korpi entitled “Oscillating Inertial Microbalance and Method of Passive Compensation” details metallic alloys and methods of utilizing two resonators fabricated out of similar materials and utilizing a differential mode, or “common mode”, wherein two resonators are utilized while only one is subjected to the collected mass. As a result the need to maintain the pressure and/or temperature of the fluid within the oscillating element to a constant value or to have a need to compensate for those variables is removed. Additionally, running mechanical resonators in “common mode” virtually eliminates the need to select materials with near zero modulus of elasticity coefficients. The need for a high mechanical Q factor material becomes a predominant design goal.

The importance of the selection of the material of construction is explained by Korpi as follows: “The oscillating element may be made of known materials used in the manufacture of microbalances, but it may also be made of other materials such as nickel alloys, inconel, quartz, and quartz-glass alloys. For example, a nickel-cobalt alloy may be used for increased strength and decreased temperature coefficient of elasticity. By applying the temperature compensation described herein, it is possible to use materials with less-restricted temperature dependencies of the modulus of elasticity, since the invention reduces the sensitivity of the instrument to external temperature variations.”

Yet another example of frequently chosen materials of construction of mechanical resonators is the classical selection of quartz alloy materials of construction for mechanical resonators utilized in inertial microbalances, such as in U.S. Pat. No. 4,391,338 by Patashnick, entitled “Microbalance and method for measuring the mass of matter suspended within a fluid medium” this system results in a very fragile mechanical resonator that has low durability and limited use in industrial environments. These devices also suffer from high elastic modulus of elasticity coefficients, meaning that as the temperature changes the devices change their resonant frequency with temperature, thereby affecting their accuracy of operation. Mechanical resonators fabricated out of the disclosed material of U.S. Pat. No. 4,391,338 are very fragile and are not suitable for use in general industry.

Coriolis Meters:

A Coriolis mass flow meter is essentially a mechanical resonator configured in a variety of geometric configurations from U shape to S shape, straight configurations as well as coaxially located tubes and vanes within a non vibrating conduit. We will use a few exemplary Coriolis type meter patents to illustrate the generic properties of Coriolis meters and how they are simply different embodiments of mechanical resonators.

When a fluid flows through a mechanical resonator, such as one configured as an oscillated flow conduit, Coriolis forces are generated. The Coriolis force is represented as a vector product obtained by multiplying together two values, the first being the rotational angular velocity of the conduit around an oscillation axis and the second being the mass flow rate. As a result of the Coriolis force tiny displacements or deflections around a deflection axis of the flow conduit, which is perpendicular to the oscillation axis, can be measured and indicate the twisting torque we attribute to the Coriolis force.

The twisting torque from the deflections caused by Coriolis force is proportional to both the spring constant of the flow conduit and the twist angle around the deflection axis. Consequently, the mass flow rate is proportional to the twist angle and the spring constant. In a Coriolis flow meter comprising an oscillated flow conduit, any variation in the conduit's spring constant results in an error in the measurement value of the mass flow rate. The material of construction for a Coriolis meter is typically chosen such that the oscillating flow conduit exhibits a spring constant that is inversely proportional to the Young's modulus of the flow conduit. Since the Young's modulus varies almost in inverse proportion to the temperature within a certain temperature range, the two phenomena compensate for one another.

Referring now to the family of mechanical resonators classified as vibrating tube resonating Coriolis meters, such as in U.S. Pat. No. 5,157,975 by Tanaka, entitled Coriolis mass flow meter employing non-metallic flow conduit structure we see a another exemplary family of resonant structures. We see in claim 2 the following:
“2. A Coriolis mass flow meter as in claim 1, wherein said at least one flow conduit further comprises:
a. a pair of flow conduits wherein each said flow conduit is coupled, mounted, oscillated, and detected as in claim 1, and
b. each said flow conduit is made from such non-metallic material, selected from the group consisting of: quartz glass, glass, ceramic, glass-ceramic, fused quartz, titanium silicate glass, silica glass, fused silica glass, lithium-aluminosilicate glass-ceramic, and borosilicate glass.”

The patent of Tanaka specifically mentions non-metallic materials of construction for corrosion resistance and for the high mechanical Q factors afforded by these materials. The selection of the glass materials results in systems that suffer from low durability in the field.

Other typical Coriolis meters utilizing hollow tubes operating similarly to the above reference patent are detailed in the following U.S. Pat. Nos. 4,829,832, 5,078,014, 5,184,518, 5,241,865, 5,355,737, and 5,359,901, whose disclosures are incorporated by reference. These patents illustrate the use of tubes in flexural excitation. The mechanical Q factors of the named materials is fairly low.

Another family of Coriolis meters is the family that comprises a resonator that is in the form of a coaxially located cylinder such as those disclosed in U.S. Pat. Nos. 4,420,330, and 5,266,330, whose disclosures are incorporated by reference. These patents illustrate the use of a coaxially located cylinder tube in flexural excitation. The mechanical Q factors of the named materials is fairly low.

Yet another family of Coriolis meters that comprises a resonator that is in the form of a non vibrating conduit with a vane, or vanes, disposed in the center of the tube being torsionally vibrated to indicate the flow such as those disclosed in U.S. Pat. Nos. 4,420,330, and 5,392,656, whose disclosures are incorporated by reference. These patents illustrate the use of a vane or vanes in torsional excitation. The mechanical Q factors of the named materials is fairly low.

As such we can see that a Coriolis meter is a family of mechanical resonators wherein the designers are concerned with the optimal materials of construction of the mechanical resonant structure.

Densitometers:

Referring now to another family of mechanical resonators, specifically vibrating densotometers. One exemplary configuration is evident in U.S. Pat. No. 6,912,904 by Storm, entitled “Single tube densitometer”. In the Storm patent we are introduced to a single tube mechanical resonator configured as a densitometer wherein a measurement device is provided that determines fluid properties from vibration frequencies of a mechanical resonator configured as a sample cavity, or sample flow tube. In one embodiment, the measurement device includes a sample flow tube, vibration source, and detector mounted on the tube, and a measurement module. The sample flow tube receives a flow of sample fluid for characterization. The measurement module employs the vibration sources to generate mechanical resonant vibrations in the tube. The measurement module combines the signals from the vibration detector on the tube to determine properties of the sample fluid, such as density, viscosity, compressibility, water fraction, and bubble size. The measurement module may further detect certain flow patterns such as slug flow, for example. To measure the sample fluid density, the measurement module determines the resonant frequency of the mechanical resonator that is configured as the sample flow tube. The density can then be calculated according to a formula that compensates for the temperature and pressure of the system. Furthermore some densitometers utilize a similar mechanical construction as is used in the construction of Coriolis meters wherein they provide a U Tube shaped sensor that is instrumented to indicate density alone. The principle of operation for this family of densitometers is very similar to the construction of Coriolis meters.

As such we can see that densitometers are a family of mechanical resonators wherein the designers are concerned with the optimal materials of construction of the mechanical resonant structure.

Vortex Meters:

Referring now to another family of mechanical resonators we will classify as vortex meters. A vortex type mass flow meter is essentially a mechanical resonator configured in a variety of geometric configurations from the configuration detailed as indicated in U.S. Pat. Nos. 4,627,295 and 4,625,564 where the resonant structure is acted upon by vortex pressure pulses causing a resonant structure to vibrate. Essentially the resonant structures do not differ much from other resonant structures in how they collect the vortex shedding frequencies and their susceptibility to the problems associated with resonant structures fabricated out of low mechanical Q factor materials. We make reference to exemplary U.S. Pat. No. 5,869,772 by Storer, entitled “Vortex flowmeter including cantilevered vortex and vibration sensing beams”. We will use the exemplary patent of Storer to illustrate the generic properties of Vortex meters and how they are various embodiments of mechanical resonators. In the Storer patent we are introduced to a vortex shedding force sensing member that shall be referred to as a resonant vortex sensor, fabricated out of a material with a very low mechanical Q factor. The reason designers of vortex meters typically utilize a resonant vortex sensor fabricated out of low mechanical Q factor material is due to the fact that a vortex meter is subjected to forces other than those that create the desired vortex shedding frequency. These forces are caused by pressure variations resulting from flow turbulence. These forces are typically lower in amplitude than base vortex shedding frequency of resonance. The classical wisdom of the prior art dictates that having a resonant vortex sensor with a low mechanical Q is desirable and preferred because the resonant vortex sensor will not resonate at any specific resonant frequency. As such, the wisdom indicates that any resonances created by the turbulent flow will be lower in magnitude than the vortex shedding frequency and a filtering scheme could be utilized to separate the resonances created by the turbulence from the basic vortex shedding frequency. The problem with these designs is that the filtering schemes can be complex and costly, mostly requiring digital signal processing to implement. The resonant vortex sensor is typically mechanically designed so that the resonant frequencies caused by turbulence are not in the range of the vortex shedding frequency. This results in a system that has to be able to discriminate the basic vortex shedding frequency from the resonant frequency of the system caused by the undesirable resonant frequencies that are caused by turbulence. As a result, designers have classically chosen to mechanically reduce the undesired resonant frequencies caused by turbulence by selecting resonant vortex sensors manufactured from a material of a low mechanical Q. The primary problem with selecting materials of low mechanical Q factors is that low mechanical Q materials have sloppy resonant frequency responses or will resonate poorly at many frequencies. This means that the filtering scheme has to work well over a broad frequency range of low amplitude noise.

As such we can see that a Vortex meters are a family of mechanical resonators wherein the designers are concerned with the optimal materials of construction of the mechanical resonant structure.

Tuning Fork Resonator:

Referring yet to another family of mechanical resonators, specifically vibrating sensors for quantifying the level and quality of fluid and particularly the viscosity, density or dielectric properties of one or more fluids. One exemplary configuration is evident in U.S. Pat. No. 7,043,969 by Matsiev, entitled “Machine fluid sensor and method”. In the Matsiev patent we are introduced to a mechanical resonator configured as a very simple resonator where one preferred embodiment consists of a simple tuning fork generally relating to the field of fluid sensors and more particularly to an automotive fluid sensor incorporating a mechanical resonator. In the Matsiev patent a method is described wherein a mechanical resonator is configured for analyzing a fluid contained within a machine, comprising the steps of providing a machine including a passage for containing a fluid; placing a sensor including a mechanical resonator in the passage; operating the resonator to have a portion thereof translate through the fluid; and monitoring the response of the resonator to the fluid in the passage. A preferred sensor includes a tuning fork resonator.

Turning forks may also be configured as an array of geometric configurations as detailed in U.S. Pat. No. 6,336,353 by Matsiev entitled “Method and apparatus for characterizing materials by using a mechanical resonator” wherein mechanical resonators are configured as the classical tuning fork resonators, trident tuning fork resonators, length extension resonators, torsion resonators, as well as thickness shear mode resonators. All of these configurations are designed with high mechanical Q factors in mind.

As such we can see that tuning forks are a family of mechanical resonators wherein the designers are concerned with the optimal materials of construction of the mechanical resonant structure.

Tuning Fork Densitometers, Viscometers, and Rheometers:

Referring yet to another family of mechanical resonators, specifically vibrating sensors for quantifying the level, density, dialetric properties, viscosity and visco-elastic properties of fluids. One exemplary configuration is evident in U.S. Pat. No. 4,729,237 by Suzuki, entitled “Tuning fork vibration-type viscosity measuring apparatus”. This mechanical resonator is an embodiment of a simple tuning fork configured as a vibration-type viscosity measuring apparatus having a pair of vibrator subassemblies that can be resonated as a tuning fork. Each of the pair of vibrator subassemblies constituting a tuning fork has at its free end a sensor plate comprised of a thin metal plate to be inserted into a sample to determine the fluid properties. Each vibrator subassembly has a center line of vibration about which the vibrator subassembly vibrates and a center of gravity aligned on the center line of vibration. An electronic detector is provided for detecting the vibration amplitude of the vibrator subassemblies that are driven together with the sensor plates at the same frequency in reverse phase relation to each other. The vibration amplitude will change due to the viscosity resistance of the sample applied to the sensor plates. A thermometer probe is provided at the intermediate point between the sensor plates and can be inserted together with the pair of sensor plates into the sample thereby simultaneously measuring the viscosity and the temperature of the sample. Rheometers are also included in this family of mechanical resonators, this is due to the fact that rheometers are viscometers that are configured to be capable of measuring visco-elastic properties of materials rather than viscosity alone. One exemplary configuration of a rheometer that is very similar in operating principle to the Suziki device, mentioned above, is a device is disclosed in U.S. Pat. No. 4,941,346 by Suzuki, entitled “Vibration-type rheometer apparatus”

As such we can see that tuning fork densitometers, viscometers, and rheometers are all a family of mechanical resonators wherein the designers are concerned with the optimal materials of construction of the mechanical resonant structure.

Vibrating Structure Gyroscopes:

Referring yet to another family of mechanical resonators, we refer specifically to vibrating structure gyroscopes. Vibrating structure gyroscopes are known in many forms such as tuning fork, hemispherical, cylinder or planar ring structures. These gyroscopes are typically made of materials such as metal quartz, polysilicon, or bulk silicon typically with a vibrating ring structure movably mounted by a number of radially compliant legs on a fixed support. One exemplary configuration is evident in U.S. Pat. No. 6,343,509 by Fell, entitled “Gyroscope.” We note the Fell patent specifically calls for a material of construction of metal quartz, polysilicon, or bulk silicon which are selected for their high mechanical Q factors. Gyroscopes fabricated from these materials are very fragile and frequently fail in the high G forces gyroscopes of this family type are subjected to, such as aerospace and space entry and exit vehicle forces.

Yet another gyroscope is indicated in U.S. Pat. No. 5,712,427 is configured as a hemispherical resonator in a flexural standing wave mode. As such the material of construction of this type of resonator is the same as the Fell patent above.

Yet more gyroscopes are indicated in U.S. Pat. No. 7,120,548 by Malvern, entitled “Method of calibrating bias drift with temperature for a vibrating structure gyroscope” disclosing the challenges of calibrating said gyroscopes. These drifts arise from non ideal vibrating structure gyroscope resonant structures.

As such we can see that vibrating structure gyroscopes are a family of mechanical resonators wherein the designers are concerned with the optimal materials of construction of the mechanical resonant structure.

Sonotrodes:

Sonotrodes are used in many industries for various applications a few, but not to be limited to these alone, exemplary uses are as follows: devices for removal of calculi from body hollows, devices for disintegrating concretions disposed in body cavities, novel designs for handpieces for use with a multifunctional operating endoscopic instruments, novel methods and equipment for producing bioactive suspensions using sonotrodes, novel methods and apparatus for disassembling joined layers utilizing sonotrodes, various methods and apparatus for transporting and depositing viscous materials for two part adhesive delivery, ultrasonic object consolidation to build 3 dimensional CAD models, to an entire array of various ultrasonic welding devices.

The term sonotrode is a very generic term given to elements of ultrasonic resonant systems, a family of mechanical resonators. Sonotrodes are sometimes called probes, anvils, ultrasonic horns, boosters, transducers and converters as well as various trade names. As such, the use of sonotrodes is wide and varied, as shown above by the wide variety of uses. The primary design criterion for sonotrodes is to utilize a material of construction for the sonotrode such that the metallic probe or sonotrode and horn assembly, if used, comprise a material with ideal acoustic impedances such as the acoustic impedance of materials such as titanium. Titanium is typically chosen because it is very efficient at transmitting sound energy, or another word for mechanical resonant energy, in short yet another measure of the mechanical Q of the material, in the case for sonotrodes. Titanium is also bio neutral, or is not toxic to the human body, so it is an ideal material for medical purposes. It is also notable that some designers of sonotrodes are concerned with corrosion resistance of the mechanical resonators.

A few exemplary patents that utilize sonotrodes with the specific selection of titanium as one material of preferred construction are as follows: U.S. Pat. Nos. 6,558,397, 6,519,500, 6,171,265, 5,413,578, 5,116,343, 4,495,885, 4,382,535, 4,304,615, 4,444,614, 5,074,474, 6,966,969, and 6,651,872 and are incorporated herein by reference as exemplary mechanical resonators.

As such we can see that sonotrodes are a family of mechanical resonators wherein the designers are concerned with the optimal materials of construction of the mechanical resonant structure.

The above exemplary mechanical resonators teach, among other things, the importance of the selection of materials of construction for mechanical resonators. In all of these systems classical metals and glass alloys are used. The use of the named materials of construction for the various forms of mechanical resonators limit the performance of the mechanical resonators.

### IN THE DRAWING

FIG. 1 is a simplified graphic illustrating the crystalline structure of most metal and glass alloys. The grain boundaries 10 are shown and it is evident how the grain boundaries 10 play a part in corrosion paths, and grain slip giving rise to low mechanical Q factors;

FIG. 2 is a simplified graphic of an amorphous structure in accordance with the present invention. We note there are no identifiable grain boundaries and instead note an amorphous or non homogenous, grain structure 10. This grain structure 10 gives rise to no grain slip or path for corrosion.

### SUMMARY OF THE INVENTION

An important object of present invention is to provide for the use of bulk-solidifying amorphous alloys, also called “Liquid Metals” as a novel material of construction for use in the fabrication and construction of mechanical resonators used in general industry, medical, and research fields.

An important object of the present invention is that it discloses the use of materials and methods to provide a system that results in mechanical resonators with a high mechanical Q factors. The advantages of using bulk-solidifying amorphous metals compared to the crystalline structure materials discussed in the above mentioned patents arise because it is the mechanical Q factor that drives the basic sensitivity, and therefore accuracy, as well as minimizing the energy necessary to initiate and maintain mechanical resonance, of most mechanical resonators.

A significant innovation of the invention is that the durability of bulk-solidifying amorphous alloys is nearly unmatched in any readily available metal or glass alloy. The durability comes from the specific strength, where the specific strength of a preferred alloy of bulk-solidifying amorphous alloys is nearly twice that of Ti 6Al-4V titanium alloy. The specific strength is the ratio of the Yield Strength over the density. The yield strength of a preferred alloy of bulk-solidifying amorphous alloys is 260 ksi (thousands of pounds per square inch) compared to the 126 ksi for the yield strength of Ti 6Al-4V titanium.

A significant innovation of bulk-solidifying amorphous alloys is that they provide corrosion resistances better than most stainless steel alloys because bulk-solidifying amorphous alloys do not have grain boundaries and therefore have virtually no corrosion path. The corrosion resistance of bulk-solidifying amorphous alloys is typically better than that of titanium alloys, such as Ti 6AL-4V.

Another advantage is the use of bulk-solidifying amorphous alloys as the material of construction of mechanical resonators is that the heat resistance offered by the ability of bulk-solidifying amorphous alloys is evident by their ability to perform at 200 Degrees Centigrade at 100% duty cycle, or up to 400 Degrees C. for short periods of time. This will be useful in high temperature systems utilizing mechanical resonators such as catalytic reduction work and high temperature exhaust sampling systems using inertial microbalances or high temperature Coriolis meters, vibrating level meters, or vortex meters.

Another object of the invention relates to the selection of mechanical resonators for vortex meters fabricated from bulk-solidifying amorphous metal alloys. This patent teaches that selecting bulk-solidifying amorphous metal alloys as a material of construction results in a very narrow resonant frequency which results in simplifying the filtering scheme for reducing the effects contributed by turbulence. In short a new paradigm dictates that selection of a resonant vortex sensor fabricated from an appropriately designed mechanical configuration using a bulk-solidifying amorphous metal alloy with a high mechanical Q factor is superior in design to a resonant vortex sensor fabricated from a material with a low mechanical Q factor. Utilizing a resonant vortex sensor fabricated out of the more rugged and higher Mechanical Q factor properties offered in bulk-solidifying amorphous alloys, also called “Liquid Metals” would result in being able to manufacture the resonant vortex sensor in a mechanical configuration to maintain the resonant frequency of the resonant vortex sensor several octaves above the expected resonant frequencies resulting from the vortex shedding frequencies. A notch filter can be utilized to electronically filter out this very narrow resonant frequency of the resonant vortex sensor by utilizing an appropriately designed resonant vortex sensor fabricated out of bulk-solidifying amorphous alloys.

The spirit of this patent, as it relates to resonant vortex sensors, is to manufacture the active resonant vortex sensor out of bulk-solidifying amorphous alloys specifically so that the known, near single valued, resonant frequency of the resonant system can be filtered out with a notch filter designed to accommodate the shift in the resonant frequency, caused by turbulence that may show up over extended temperature ranges. The design concept teaches that it is less difficult to design a near single valued notch filter to filter out the resonant frequencies created by the turbulence than it is to utilize multiple filters designed to operate over a wide range of a sloppy resonant structure such as those afforded by selecting materials with low mechanical Q factors.

Another object of the present invention is to provide a material of construction that is robust.

Briefly, a preferred embodiment of the present invention includes a preferred bulk-solidifying amorphous metal for use in the construction of the above mentioned exemplary mechanical resonators has a composition, in atomic percent, of from about 45 to about 67 percent total of zirconium plus titanium, from about 10 to about 35 percent beryllium, and from about 10 to about 38 percent total of copper plus nickel, plus incidental impurities, the total of the percentages being 100 atomic percent.

The selections of the specific percentages would be chosen to suit the particular mechanical resonator application and are established by varying the compositions and thence the physical properties of the bulk-solidifying amorphous alloys.

A most preferred such metal alloy material, termed Vitreloy™-1 trademark of Liquidmetal Technologies, Inc. Lake Forest, Calif., has a composition, in atomic percent, of about 41.2 percent zirconium, 13.8 percent titanium, 10 percent nickel, 12.5 percent copper, and 22.5 percent beryllium. This material exhibits a very high mechanical Q factor because this alloy of bulk-solidifying amorphous alloy, termed Vitreloy™-1, exhibits a large fully-elastic deformation without any yielding.

In summary, the atomic structure of bulk-solidifying amorphous alloys configured as mechanical resonators leads to a unique set of characteristic properties for the family of bulk-solidifying amorphous alloys as follows: High Yield Strength, High Hardness, Superior Strength/Weight Ratio, Superior Elastic Limit, High Corrosion Resistance, High Wear-Resistance, and Unique Acoustical Properties.

A direct result of the unique atomic structure of bulk-solidifying amorphous alloys configured as mechanical resonators give rise to the very high yield strength, which approaches the theoretical limit and far exceeds the strength currently available in crystalline metals and alloys. For example, yield strength of over 250 ksi has been achieved in Zr-base and Ti-base bulk-solidifying amorphous alloys which is more than twice the strength of conventional titanium alloys.

Another unique property of bulk-solidifying amorphous alloys configured as mechanical resonators is the superior elastic limit; i.e., the ability to retain its original shape (memory) after undergoing very high loads and stress. Furthermore, the bulk-solidifying amorphous alloys configured as mechanical resonators have much higher corrosion and wear resistance than their conventional (crystalline) counterparts. This is due to the unique amorphous atomic structure of bulk-solidifying amorphous alloys.

There remains a need, however, for further improvements in mechanical resonators, of other types, in order to attain high mechanical Q factors, corrosion resistance, and specific strength. These properties, in turn, lead to better performing mechanical resonators. The present invention fulfills this need, and further provides advantages related to increased sensitivity, less energy to initiate and sustain mechanical resonance, increased frequency for a specific geometry, faster reading times and more. These and other objects and advantages of the present invention will no doubt become apparent to those skilled in the art after having read the following detailed description of the invention.

### DETAILED DESCRIPTION OF THE INVENTION

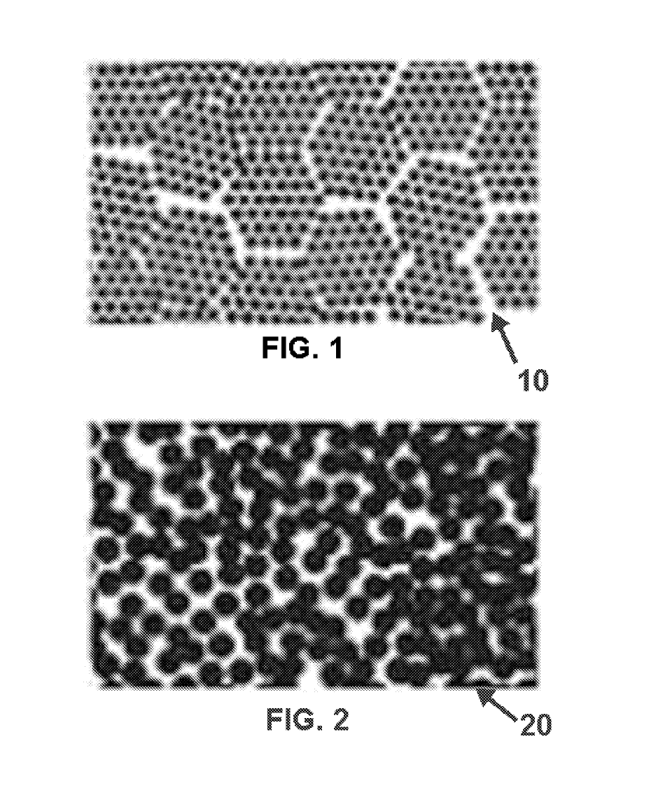

The primary design goals for the selection of bulk-solidifying amorphous alloys in mechanical resonators centers around their need for materials of construction that provide for extraordinarily high Q factors. The reason bulk-solidifying amorphous alloys exhibit high Q factors has to do with their atomic structure. FIG. 2 depicts a bulk-solidifying amorphous alloy showing the amorphous structure 10, compared to the crystalline structure illustrated in FIG. 1 where the grain boundaries are shown in FIG. 1 at 10. The atomic structure is arranged so that there is no lattice slip at the grain boundaries in bulk-solidifying amorphous alloys. As such the material is not crystallized; instead it is virtually a “single crystal”. The bulk-solidifying amorphous alloy material is amorphous, having no long range order of the position of the atoms, resulting in having bulk-solidifying amorphous alloys “look” like fused silica, but are stronger than titanium.

Another important material property giving rise to the high mechanical Q factor of bulk-solidifying amorphous alloys is the energy dissipation for each cycle of resonance. Given that the Mechanical Q factor is directly related to the energy dissipation per each cycle of resonance we can observe that most other metallic alloys will exhibit microyielding in grains oriented for plastic microslip, even at applied stresses and strains below the yield point. For many applications the microyielding is not an important consideration. However, when most other metallic alloys are used in mechanical resonators the dynamic mechanical resonating causes microyielding that absorbs and dissipates energy that otherwise would be retained in the resonant structure. The fact that bulk-solidifying amorphous alloys do not exhibit microyielding give rise to another observed property that contributes to the high mechanical Q factor of bulk-solidifying amorphous alloys.

Bulk-solidifying amorphous alloys have recently come out of the R&D realm to general industry because the manufacturing processes have advanced from the requirement of cooling the bulk-solidifying amorphous alloys at a rate of 1 million degrees per second to the subject bulk-solidifying amorphous alloys requiring cooling rates in the range of 500 degrees per second. It should be noted that the 1 million degree per second families of bulk-solidifying amorphous alloys are typically limited to thin foil configurations where the newer processes, in the range of 500 degrees per second, are able to produce stock from 2 mm thick to 4 mm thick easily with processes promising up to 25 mm thick sections.

The bulk-solidifying amorphous alloys are essentially a glass. Glass, while mechanically weak, is one of the most elastic materials available for mechanical resonator applications. The elasticity of bulk-solidifying amorphous alloys is about 1.9% compared to 0.69% for Ti 6AL-4V. This is an extraordinary property giving rise to another contribution of the high mechanical Q of bulk-solidifying amorphous alloys. Bouncing a bulk-solidifying amorphous alloy ball and a rubber ball on a solid surface one would observe that the bulk-solidifying amorphous alloy ball will bounce higher because the bulk-solidifying amorphous alloy is very elastic. This is because there is no lattice slip between grain boundaries such as there is with materials having crystalline structures. Additionally, bouncing a stainless steel ball bearings on aluminum, stainless steel, titanium, and bulk-solidifying amorphous alloy plates one would observe that the stainless steel ball would bounce more than twice as long on the bulk-solidifying amorphous alloy plate as compared to titanium. This demonstration is a rather elementary demonstration of a resonant system because it illustrates the mechanical Q factor quite readily. Since the bulk-solidifying amorphous alloy causes the ball to bounce longer it is evident that the mechanical Q factor is at play. Also, acoustics engineers will now recognize, from this discussion, that the resulting acoustic properties of this material are evident and noteworthy even in speaker driver designs.

Bulk-solidifying amorphous alloys have very low thermal conductivities resulting in an extremely localized dissipation of energy. This localized dissipation of the energy further contributes to the long bouncing time, or high mechanical Q factor. As such the bulk-solidifying amorphous alloys will dissipate highly localized impact energy right up to the tensile yield point and shatter like glass when exercised up to the tensile yield point. In fact the localized temperatures, if exercised up to and past the tensile yield point, can increase to the point of igniting the material, since the thermal energy can not dissipate.

It is also very important to note that bulk-solidifying amorphous alloys are “stronger”, or their specific strength, (the ratio of the yield strength to the density) is nearly twice that of Titanium and more than five times that of aluminum. This gives rise to the design of mechanical resonators that would be heretofore impossible because classical materials would fatigue and lose their properties. Bulk-solidifying amorphous alloys will operate right up to their tensile yield points.

Bulk-solidifying amorphous alloys also exhibit exceptional corrosion resistance because of their atomic structure. Bulk-solidifying amorphous alloys exhibit very good corrosion resistance, due to the absence of grain boundaries. Lacking grain boundaries there is very little corrosion path for corrosive materials and they therefore exhibit corrosion resistance properties similar to that of Ti6Al-4V. Another important advantage of manufacturing mechanical resonators out of bulk-solidifying amorphous alloys arises out of the fact that there is no need for surface treatment, to protect the mechanical resonator from corrosive attack, as surface treatments can lead to degradation of the mechanical Q factor.

Bulk-solidifying amorphous alloys have as-cast surfaces that are very attractive and smooth, when cast against a smooth surface, they exhibit low coefficients of friction giving rise to even higher resistance to corrosive attack.

Bulk-solidifying amorphous alloys may be readily cast as mechanical resonators using a number of techniques, most preferably permanent mold casting, permitting fabrication of the components at reasonable cost because secondary machining options are simplified.

Preferably, the mechanical resonator is made at least in part of a bulk-solidifying amorphous alloy, preferably by casting the alloy to shape in a properly configured mold or by machining tube, plate, or round stock to the desired geometry. Bulk-solidifying amorphous alloys are a recently developed class of amorphous alloys that retain their amorphous structures when cooled from high temperatures at critical cooling rates of about 500 degrees C. per second or less, depending upon the alloy composition. Bulk-solidifying amorphous alloys have been described, for example, in U.S. Pat. Nos. 5,711,363, 5,618,359, 5,288,344, 5,368,659, and 5,032,196, whose disclosures are incorporated herein by reference. Methods of producing bulk-solidifying amorphous alloys in the form of tube stock are in development and will most likely be commonplace and are incorporated herein as viable forms for mechanical resonators described in this patent.

Mechanical resonator components made of the bulk-solidifying amorphous alloy are preferably made by “permanent mold casting”, which, as used herein, includes die casting or any other casting technique having a permanent mold into which metal is introduced, as by pouring, injecting, vacuum drawing, or the like. While typically more expensive, some mechanical resonators may be more efficiently fabricated from plate or round stock, and, in the future, tube stock, to attain the desired characteristics.

A typical method of forming a bulk-solidifying amorphous alloy is as follows: A bulk-solidifying amorphous alloy is introduced into a permanent mold having a mold cavity defining the shape of the mechanical resonator component or tube, plate, or bar stock. The bulk-solidifying amorphous alloy is then heated to a temperature such that it may be introduced into the permanent mold. The bulk-solidifying amorphous alloy is cooled to relatively low temperature, such as room temperature, at a rate sufficiently high such that the amorphous structure is retained in the final cast product. This cast product may be the finished product as well as tube, plate, or bar stock for further machining to create the desired mechanical resonator geometry.

Contrasting the aforementioned method above with the processing used with conventional materials we note mechanical resonators are conventionally made of relatively high mechanical Q factor materials such as quartz or glass alloys or metallic alloys that are machined, cast, or drawn by glass blowers or even fabricated out of metallic tubing that is subsequently heat treated. These processes are difficult to reproduce and cause resonators that typically require fairly complex characterization procedures to quantify the operating characteristics. The use of as cast mechanical resonators fabricated from bulk-solidifying amorphous result in highly reproducible characteristics. As such mechanical resonator components made by permanent-mold casting of bulk-solidifying amorphous alloys overcome the shortcomings of the prior approaches by achieving good tolerances with much lower cost than are possible with hand blown glass alloys or metallic tubes that require heat treating to attain optimal mechanical Q factors. The bulk-solidifying components made by permanent-mold casting have low or negligible shrinkage and porosity, leading to good strength and also to low variation in net shape. They also exhibit excellent surface finish and replication of the mold interior. The lack of solidification shrinkage and consequent warping of bulk-solidifying amorphous gives rise to taking note that the methods of casting of conventional crystalline alloys that does not permit the advantages of net-shape casting possible with the bulk-solidifying amorphous alloys.

The preferred bulk-solidifying amorphous alloys used in the manufacture of mechanical resonators are selected such that they exhibit exceedingly high strength-to-density ratios, on the order of twice that of metals such as steel and Ti-6Al-4V alloys. This property of the materials may be characterized as a strength-to-density ratio of at least about 10⁶ inches, and preferably greater than about 1.2*10⁶ inches. This feature, together with the high elastic limit of the amorphous material and its low damping properties, therefore high mechanical Q factor, permits the surprising and unexpected redesign opportunities of mechanical resonators to achieve improved mechanical resonator performance that are the subject of this patent.

Bulk-solidifying amorphous metal alloys may be cooled from the melt at relatively low cooling rates, on the order of 500 degrees C. per second or less, while still retaining an amorphous structure. Bulk-solidifying amorphous alloy metals do not experience a liquid/solid crystallization transformation upon cooling, as with conventional metals. Instead, the highly fluid, non-crystalline form of the metal found at high temperatures becomes more viscous as the temperature is reduced, eventually taking on the outward physical appearance and characteristics of a conventional solid.

Even though there is no liquid/solid crystallization transformation for bulk-solidifying amorphous alloy metals, an effective “freezing temperature”, T_{g} (often referred to as the glass transition temperature), may be defined as the temperature below which the viscosity of the cooled liquid rises above 10¹³ poise. At temperatures below T_{g} the material is for all practical purposes a solid. An effective “fluid temperature”, T_{f}, may be defined as the temperature above which the viscosity falls below 10² poise. At temperatures above T_{g}, the material is for all practical purposes a liquid. At temperatures between T_{f} and T_{g}, the viscosity of the bulk-solidifying amorphous metal changes slowly and smoothly with temperature. For the zirconium-titanium-nickel-copper-beryllium alloy of the preferred embodiment, T_{g} is about 350-400 degrees C. and T_{f} is about 700-800 degrees C.

This ability to retain an amorphous structure even with a relatively slow cooling rate is to be contrasted with the behavior of other types of amorphous metals that require cooling rates of at least about 10⁴-10⁶ degrees C. per second from the melt to retain the amorphous structure upon cooling. Such metals may only be fabricated in amorphous form as thin ribbons or particles. Because we frequently need thick cross sections for mechanical resonators we can see the benefit of this method of forming bulk-solidifying amorphous alloys at low cooling rates. Bulk-solidifying amorphous alloys with high cooling rates have limited usefulness because it cannot be prepared in the thicker sections required for typical mechanical resonators. There are indeed many applications for thin sections such as those frequently used in some types of vibrating structure gyroscopes, such as those discussed above and disclosed in U.S. Pat. No. 6,343,509, by Fell, incorporated herein by reference.

A preferred type of bulk-solidifying amorphous alloy for use in the manufacture of mechanical resonators has a composition of about that of a deep eutectic composition. Such a deep eutectic composition has a relatively low melting point and a steep liquidus. The composition of the bulk-solidifying amorphous alloy should therefore preferably be selected such that the liquidus temperature of the amorphous alloy is no more than about 50-75 degrees C. higher than the eutectic temperature, so as not to lose the advantages of the low eutectic melting point.

A most preferred type of bulk-solidifying amorphous alloy family for use in the manufacture of mechanical resonators has a composition near a eutectic composition, such as a deep eutectic composition with a eutectic temperature on the order of 660 degrees C. This material has a composition, in atomic percent, of from about 45 to about 67 percent total of zirconium plus titanium, from about 10 to about 35 percent beryllium, and from about 10 to about 38 percent total of copper plus nickel, plus incidental impurities, the total of the percentages being 100 atomic percent. A substantial amount of hafnium may be substituted for some of the zirconium and titanium, aluminum may be substituted for the beryllium in an amount up to about half of the beryllium present, and up to a few percent of iron, chromium, molybdenum, or cobalt may be substituted for some of the copper and nickel. This bulk-solidifying alloy is known and is described in U.S. Pat. No. 5,288,344.

A most preferred such metal alloy material, termed Vitreloy™-1, has a composition, in atomic percent, of about 41.2 percent zirconium, 13.8 percent titanium, 10 percent nickel, 12.5 percent copper, and 22.5 percent beryllium. This material exhibits a very high mechanical Q factor because this alloy of bulk-solidifying amorphous alloy, termed Vitreloy™-1, exhibits a large fully-elastic deformation without any yielding.

The spirit of the patent is to select the atomic percentages of the materials that result in the highest mechanical Q and the lowest coefficient of elastic modulus while still being appropriate for the selected fabrication methods.

Another such metal alloy family material has a composition, in atom percent, of from about 25 to about 85 percent total of zirconium and hafnium, from about 5 to about 35 percent aluminum, and from about 5 to about 70 percent total of nickel, copper, iron, cobalt, and manganese, plus incidental impurities, the total of the percentages being 100 atomic percent. A most preferred metal alloy of this group has a composition, in atomic percent, of about 60 percent zirconium about 15 percent aluminum, and about 25 percent nickel. This alloy system is less preferred than that described in the preceding paragraph, because of its aluminum content. Other bulk-solidifying alloy families, such as those having even higher contents of aluminum and magnesium, are operable but even less preferred because of the lower mechanical Q factors.

The use of bulk-solidifying amorphous alloys in mechanical resonators offers exceptional advantages over conventional glass alloys, quartz alloys, and various metals used as materials of construction. The bulk-solidifying amorphous alloys exhibit a large fully-elastic deformation without any yielding, as noted above for the Vitreloy™-1. This bulk-solidifying amorphous alloy strains a mere 2 percent and to a stress of about 270 ksi without yielding, which is extraordinary for a bulk material, and is mostly responsible for the mechanical Q factor being is as high as it is.

The energy stored when the material is stressed to the yield point, sometimes termed U_{d}, is 2.7 ksi. By comparison the titanium Ti 6AL-4V alloy yields at a strain of about 0.65 percent and a stress of about 110 ksi, with a stored energy U_{d} to the yield point of about 0.35 ksi. This property gives rise to the extremely high mechanical Q factor for mechanical resonators fabricated out of bulk-solidifying amorphous alloys. For comparison we note one of the best metallic materials for energy storage, a Beryllium Copper alloy that has a U_{d} of about 1.15 ksi, less than half that of the preferred bulk-solidifying amorphous alloy. It is important to note too that even though Beryllium Copper, being one of the next best materials for energy storage, Beryllium Copper must be handled with care. Gloves and masks are recommended for anyone handling this material. Beryllium Copper may have a carcinogenic effect if inhaled. As such alloys of Beryllium Copper are not advisable for mechanical resonators due to the health hazards of handling beryllium.

From these illustrative examples, it is apparent that the mechanical resonator designer has available an important new approach by which mechanical resonators may be designed both as to their ability to be formed to the required physical configuration and the highest available mechanical Q factor. The selection of these characteristics permits the mechanical resonator to be tailored to individual performance and characteristics required by each specific mechanical resonator. For example the tubing for a Coriolis meter would need to be selected from an alloy that lends itself to the fabrication of tubing, while a simple tuning fork type mechanical resonator would be cast as described above in a permanent mold.

Mechanical resonators fabricated out of bulk-solidifying amorphous metal exhibit very high mechanical Q factors compared to classically chosen glass and metal alloys.

Although particular embodiments of the invention have been described in detail for purposes of illustration, various modifications and enhancements may be made. It is therefore intended that the following claims be interpreted as covering all such alterations and modifications as fall within the true spirit and scope of the invention.

### OTHER REFERENCES

Akihisi Inoue et al., “Production of Amorphous Cylinder and Sheet of La 55 Al 25 Ni 20 alloy by a Metallic Mold Casting Method,” Materials Transactions, JIM, vol. 31, No. 5 (May 1990).

A. Peker et al., “A highly processable metalllic glass: Zr 41.2 Ti 13.6 Cu 12.5 Be 22.5,”Appl. Phys. Lett., vol. 63, No. 17 (Oct. 25, 1993).

A. Inoue et al., “Mg—Cu—Y Bulk Amorphous Alloys with High Tensile Strength Produced by a High-Pressure Die Casting Method,” Materials Transactions, JIM, vol. 33, No. 10 (October 1992).

Tao Zhang et al., “Amorphous Zr—Al-TM (TM=Co,Ni,Cu) Alloys with Significant Supercooled Liquid Region of Over 100K”, Materials Transactions, JIM, vol. 32, No. 11, November 1991.

K. A. Bruck et al., “Quasi-Static Constitutive Behavior of Zr 41.25 Ti 1.75 Ni 10 Cu 12.5 Be 12.5 Bulk Amorphous Alloys,” Scripta Metallurgica et Materialia, vol. 30, pp. 429-434.

What is claimed is:

1. A mechanical resonator made at least in part of a bulk-solidifying amorphous metal alloy.

2. The mechanical resonator of claim 1, wherein the mechanical resonator is a resonator for an inertial microbalance.

3. The mechanical resonator of claim 1, wherein the mechanical resonator is a resonator for a coriolis meter.

4. The mechanical resonator of claim 1, wherein the mechanical resonator is a resonator for a densitometer.

5. The mechanical resonator of claim 1, wherein the mechanical resonator is a resonator for a vortex meter.

5. The mechanical resonator of claim 1, wherein the mechanical resonator is a resonator for a tuning fork resonator.

6. The mechanical resonator of claim 1, wherein the mechanical resonator is a resonator for tuning fork densitometers, viscometers, or rheometers.

7. The mechanical resonator of claim 1, wherein the mechanical resonator is a resonator for vibrating structure gyroscopes.

8. The mechanical resonator of claim 1, wherein the mechanical resonator is a resonator for sonotrodes.

9. The mechanical resonator of claim 1, wherein the mechanical resonator is a resonator for piezoelectric activated mechanical resonators.

10. The mechanical resonator of claim 1, wherein the bulk-solidifying amorphous metal has a composition, in atomic percent, of from about 45 to about 67 percent total of zirconium plus titanium, from about 10 to about 35 percent beryllium, and from about 10 to about 38 percent total of copper plus nickel, plus incidental impurities, the total of the percentages being 100 atomic percent.

11. The mechanical resonator of claim 1, wherein the bulk-solidifying amorphous metal has a composition, in atomic percent, of from about 25 to about 85 percent total of zirconium and hafnium, from about 5 to about 35 percent aluminum, and from about 5 to about 70 percent total of nickel, copper, iron, cobalt, and manganese, plus incidental impurities, the total of the percentages being 100 atomic percent.

12. The mechanical resonator of claim 1, wherein the bulk-solidifying amorphous alloy exhibits substantially no plastic deformation when loaded to about 80 percent of its fracture strength.

13. The mechanical resonator of claim 1, wherein the bulk-solidifying amorphous alloy has an elastic strain limit of at least about 1.5 percent strain.

14. The mechanical resonator of claim 1, wherein the bulk-solidifying amorphous alloy has a strength-to-density ratio of at least about 1*10⁶ inches.

15. The mechanical resonator of claim 1, wherein the amorphous metal has a strength-to-density ratio of at least about 10⁶ inches, an elastic strain limit of more than about 1.5 percent, and a density of from about 5.0 to about 7.0 grams per cubic centimeter.

16. A mechanical resonator, wherein at least part of the mechanical resonator is made of a bulk-solidifying amorphous metal that may be fabricated by casting the bulk-solidifying amorphous metal to shape in a properly shaped permanent mold.

17. The mechanical resonator of claim 16, wherein the bulk-solidifying amorphous metal has a composition, in atomic percent, of from about 45 to about 67 percent total of zirconium plus titanium, from about 10 to about 35 percent beryllium, and from about 10 to about 38 percent total of copper plus nickel, plus incidental impurities, the total of the percentages being 100 atomic percent.

18. The mechanical resonator of claim 16, wherein the bulk-solidifying amorphous metal has a composition, in atomic percent, of from about 25 to about 85 percent total of zirconium and hafnium, from about 5 to about 35 percent aluminum, and from about 5 to about 70 percent total of nickel, copper, iron, cobalt, and manganese, plus incidental impurities, the total of the percentages being 100 atomic percent.

19. The mechanical resonator of claim 16, wherein the metal is a bulk-solidifying amorphous metal that may be cooled from the melt at a cooling rate of about 500 degrees C. per second or less, yet retain an amorphous structure.

20. A mechanical resonator, wherein at least part of the mechanical resonator is made of a bulk-solidifying amorphous metal that may be cooled from the melt at a cooling rate of about 500 degrees C. per second or less, yet retain an amorphous structure, and wherein the mechanical resonator is fabricated by casting the bulk-solidifying amorphous metal to shape in a properly shaped permanent mold.
